(19) United States
(12) Patent Application Publication
(10) Pub. No.: US 2026/0356683 A1
(43) Pub. Date: Nov. 12, 2026

(54) PROCESS FOR PRODUCING A FUSED MAYENITE PRODUCT

(71) Applicant: SAINT-GOBAIN CENTRE DE RECHERCHES ET D'ETUDES EUROPEEN, Courbevoie (FR)

(72) Inventors: Nadia FREDERICH, L'Isle Sur La Sorgue (FR); Caroline TARDIVAT, Aix-En-Provence (FR)

(21) Appl. No.: 19/125,731

(22) PCT Filed: Nov. 3, 2023
(86) PCT No.: PCT/EP2023/080658

§ 371 Date: Apr. 29, 2025

(30) Foreign Application Priority Data
Nov. 3, 2022 (FR) 2211432

(51) Int. Cl. C01F 7/164

(52) U.S. Cl. CPC C01F 7/164; C01P 2002/54; C01P 2002/82; C01P 2006/40; C01P 2006/80

(57) ABSTRACT

A process for producing mayenite includes: a) making a feedstock suitable for obtaining, at the end of step c), a product comprising more than 90% of a mayenite comprising calcium and/or strontium, aluminium and oxygen, as a percentage by weight based on the weight of the crystallised phases. The process further includes b) melting the feedstock until a molten material is obtained and c) cooling the molten material so as to solidify it and obtain a fused polycrystalline product, where the melting being carried out with an electric arc furnace and in a reducing medium.

### TECHNICAL FIELD

The present invention relates to a fused product of mayenite electride and to a process for manufacturing such a product. Lastly, the invention relates to devices comprising a fused product according to the invention or a fused product manufactured by a process according to the invention.

### PRIOR ART

EP 1 717 217 describes mayenites in the form of an electride, or “mayenite electrides”, comprising calcium and/or strontium, aluminum and oxygen, especially mayenites of the formulae ((Ca₂₄Al₂₈O₆₄)⁴⁺)(4e⁻) and ((Sr₂₄Al₂₈O₆₄)⁴⁺)(4e⁻). These mayenites are manufactured by melting a feedstock, maintaining the molten material in an atmosphere having an oxygen partial pressure of less than or equal to 10 Pa, and then cooling.

The article “Mayenite-based electride C12A7e⁻: an innovative synthetic method via plasma arc melting”, Materials Chemistry Frontiers, 2021, pages 1301-1314, by Weber Sebastian et al., describes a process for manufacturing a mayenite-based electride by melting using a plasma furnace.

A mayenite in the form of an electride can also be obtained by solid-phase sintering followed by replacing oxygen ions present in the nano-cages with electrons. This replacement can, for example, result from exposure to reducing metal vapors.

It is also known that the electrons of a mayenite in the form of an electride can be partially or totally replaced by anions, disposed in the nano-cages of the mayenite. If the replacement is partial, the electrons keep the mayenite electrically conductive, that is to say, in the form of an electride. Otherwise, the mayenite becomes electrically insulating, and is therefore no longer an electride.

Processes for manufacturing mayenite in the form of an electride comprising calcium and/or strontium, aluminum and oxygen are complex and expensive. They can only manufacture small amounts of mayenite. There is therefore an ongoing need for a simpler manufacturing process for manufacturing mayenite, in particular in the form of an electride, in large amounts.

An object of the invention is to respond, at least in part, to this need.

### SUMMARY OF THE INVENTION

According to the invention, this object is achieved by means of a process for manufacturing mayenite in the form of an electride, said process comprising the following successive steps:
a) preparing a feedstock;
b) melting said feedstock until a molten material is obtained,
c) cooling said molten material so as to solidify it and obtain a polycrystalline fused product, said feedstock being suitable, in step a), to obtain, at the end of step c), a product comprising more than 90% of a mayenite comprising calcium and/or strontium, aluminum and oxygen, as percentage by mass based on the mass of the crystalline phases;
d) optionally, grinding the fused product into the form of a powder;
e) optionally, particle size selection on the powder;
f) optionally, replacing only a portion of the free electrons of the mayenite of said fused product by anions, disposed in nano-cages of the mayenite, preferably selected from F⁻, Cl⁻, OH⁻, H⁻, O₂⁻, O⁻, O₂⁽²⁻⁾, N³⁻, NH²⁻, NH₂⁻, C₂⁽²⁻⁾, S⁻, CN⁻, NO₂⁻, S₂⁻, and mixtures thereof, an anion in a nano-cage possibly differing depending on the nano-cage considered or, preferably, being identical irrespective of the nano-cage considered,
   said melting being carried out with an electric arc furnace and in a reducing medium.

In other words, the melting is carried out using the heat produced by an electric arc passing through the feedstock.

As will be seen in greater detail in the remainder of the description, the inventors have discovered that the above process is simple and inexpensive because it comprises just a single melting step, makes it possible to manufacture a fused product comprising a very large amount of mayenite electride at the end of step c).

The manufacturing process according to the invention may also exhibit one or more of the following optional features:
in step b) the electrodes of the electric arc furnace dip into the molten material;
in step a) the feedstock comprises more than 0.5% of a reducing agent, as percentage by mass based on the mass of the feedstock;
in step a) the feedstock comprises less than 7% of a reducing agent, as percentage by mass based on the mass of the feedstock;
the reducing agent is selected from a carbon source, a metal, and mixtures thereof;
in step a) the feedstock contains less than 50% mayenite comprising
   calcium and/or strontium,
   aluminum and
   oxygen;
in step c) the cooling is adapted such that the molten material is fully solidified in less than 3 minutes.

In one embodiment, step f) is replaced by a step f) which differs from step f) in that substantially all of the free electrons of the mayenite of said fused product are replaced by anions, disposed in nano-cages of the mayenite, preferably selected from F⁻, Cl⁻, OH⁻, H⁻, O₂⁻, O⁻, O₂⁽²⁻⁾, N³⁻, NH²⁻, NH₂⁻, C₂⁽²⁻⁾, S⁻, CN⁻, NO₂⁻, S₂⁻, and mixtures thereof, an anion in a nano-cage possibly differing depending on the nano-cage considered or, preferably, being identical irrespective of the nano-cage considered. Step f) thus renders the mayenite electrically insulating.

The invention also relates to a polycrystalline fused product comprising more than 90% mayenite, as percentage by mass based on the crystalline phases, said mayenite comprising
calcium and/or strontium,
aluminum and
oxygen,
   said fused product comprising carbon in an amount of greater than 15 ppm and less than or equal to 5%, by mass based on the mass of the fused product; said mayenite being:
preferably in the form of an electride, or
electrically insulating.

In a polycrystalline product, an amount of carbon of greater than 15 ppm and less than or equal to 5% and an amount of mayenite of greater than 90%, as percentage by mass based on the crystalline phases, are considered to be a signature of a step of melting in an electric arc furnace and in a reducing medium. The product according to the invention may therefore be manufactured by a process according to the invention. In a preferred embodiment, said product is obtained according to a process according to the invention.

The fused product obtained directly by a process according to the invention, that is to say without having undergone additional treatment, has a color that is representative of its electrical conductivity. The color of an insulating mayenite is white. The color of a mayenite in the form of an electride is between cream yellow and black, preferably between green and black. Preferably, mayenite in the form of an electride is dark green or black, preferably black. The closer the color is to black, the higher the electrical conductivity.

As described in EP 3 489 197, a color between cream yellow and yellow corresponds to an electrical conductivity of less than 1·10⁻⁴ S/cm, a green color corresponds to an electrical conductivity of between 1·10⁻⁴ S/cm and 1 S/cm and a black color corresponds to an electrical conductivity of greater than 1 S/cm.

In one embodiment of a mayenite in the form of an electride, the total amount of the elements Ca, Sr, Al, C and O, Ca+Sr+Al+O+C, is greater than 97%, as percentage by mass based on the mass of the fused product.

A polycrystalline fused product according to the invention may also comprise one or more of the following optional features:
the product includes more than 95%, preferably more than 98%, mayenite in the form of an electride, as percentage by mass based on the crystalline phases;
the product has a carbon content of greater than 300 ppm, preferably greater than 700 ppm, and/or and less than 3%, preferably less than 1.5%;
the product has a total amount of the elements Ca, Sr, Al, C and O, Ca+Sr+Al+O+C, of greater than 97%, preferably greater than 98%, as percentage by mass based on the mass of the fused product;
the product has a (CaO+SrO)/Al₂O₃ ratio, CaO, SrO, and Al₂O₃ being molar contents based on the oxides, of greater than 1.60, preferably greater than 1.68, and/or less than 2, preferably less than 1.80;
the mayenite comprises at least one element selected from Mg, K, Na, Li, Ba, Ga, Si, Ge, Sn, Ti, Zr, Cr, Mn, Fe, Co, Ni, Cu, Zn.

Lastly, the invention relates to a device comprising a product according to the invention and/or a product manufactured by a process according to the invention.

When the product is in the form of an electride, said device is selected from:
a catalyst support, in particular for the synthesis of NH₃ or the decomposition of CO₂;
a solid oxide fuel cell (or SOFC), in particular an electrode, especially a cathode;
an organic light-emitting diode (or OLED), in particular a cathode of such a diode;
a Hall-effect thruster, in particular a cathode of such a thruster;
a gridded ion thruster, (or ion thruster) in particular a cathode of such a thruster;
a proton-conducting ceramic fuel cell (or PCFC).

When the product is electrically insulating, the device is chosen from:
a solid oxide fuel cell (or SOFC), in particular an electrolyte of such a cell;
a solid oxide electrolysis cell (or SOEC);
a CO₂ capture device.

The device may also be a hydrogen storage and/or transport device, the product being in the form of an electride or being electrically insulating.

### DEFINITIONS

An “electride” is conventionally an ionic compound in which trapped electrons play the role of negatively charged ions.

The term “mayenite” is conventionally understood to mean a compound with the chemical formula 12CaO·7Al₂O₃ or 12SrO·7Al₂O₃ or 12(Ca,Sr)O·7Al₂O₃, in which a portion of the Ca and/or Sr and/or Al may optionally be substituted by another element, in particular by Mg, K, Na, Li, Ba, Ga, Si, Ge, Sn, Ti, Zr, Cr, Mn, Fe, Co, Ni, Cu, Ir, V, P, Er, Yb, Eu, Au, Tb or Zn. A mayenite crystal has a crystal lattice forming nano-cages. A mayenite is electrically neutral.

An electrically insulating mayenite can conventionally be considered as containing, per unit cell, 12 nano-cages and two O²⁻ ions in said nano-cages, said O²⁻ ions conventionally being referred to as “free oxygens”. Said electrically insulating mayenite can be expressed by the formula ((Ca₂₄Al₂₈O₆₄)⁴⁺)(O²⁻)₂.

It is known that all or a portion of the free oxygens can conventionally be replaced by electrons, referred to as “free electrons”, and considered to be localized within the nano-cages: the initially electrically insulating mayenite then becomes electrically conductive, that is to say is in the form of an electride. In the particular case in which all of the free oxygens are replaced by free electrons, a mayenite is obtained in the form of an electride conventionally expressed by the formula ((Ca₂₄Al₂₈O₆₄)⁴⁺)(4e⁻).

It is also known that all or a portion of the free oxygens and/or the free electrons can be replaced by anions such as for example F⁻ (the number of F⁻ anions making it possible to ensure electroneutrality).

To express a composition or content “based on the oxides”, all elements other than carbon are converted into the form of their most stable oxide, according to the usual industry convention. For example, the contents of the elements calcium, strontium and aluminum are expressed after conversion of these elements into the form of CaO, SrO and Al₂O₃, respectively. The content of an element other than carbon thus converted is expressed based on all of the elements other than carbon thus converted.

In particular, the contents of CaO, SrO and Al₂O₃ relate to the overall contents for each of the corresponding chemical elements Ca, Sr and Al. The contents of CaO, SrO and Al₂O₃ mentioned in the present description therefore express the contents of the elements Ca, Sr and Al not only in the form of CaO, SrO and Al₂O₃ phases, but also in other forms. This therefore includes in particular the contents of the elements Ca, Sr and Al in the form of suboxides and optionally nitrides, oxynitrides, carbides, oxycarbides, carbonitrides, or even metals.

When reference is made to an oxide phase, for example to a CaO, SrO or Al₂O₃ phase, this is specified by indicating CaO, SrO or Al₂O₃ “phase”.

The total amount of the elements Ca, Sr, Al, C and O, Ca+Sr+Al+O+C, is expressed as percentage by mass based on the mass of the fused product, without converting the metals into the form of the most stable oxide.

The term “impurities” is understood to mean the inevitable constituents, necessarily introduced with the starting materials. In particular, compounds belonging to the group of the oxides, nitrides, oxynitrides, carbides, oxycarbides, carbonitrides and metal species of silicon, sodium and other alkali metals, iron, and vanadium are impurities, especially when substitution of a portion of the elements Ca and/or Sr and/or Al of the mayenite is not sought.

The term “precursor” of an oxide is understood to mean a constituent capable of providing said oxide during the manufacture of a fused product according to the invention.

The term “fused product” is understood to mean a solid product obtained by solidification, by cooling, of a molten material.

A “molten material” is a mass rendered liquid by heating a feedstock, which may contain a few solid particles but in an amount insufficient for them to be able to structure said mass. To retain its shape, a molten material must be contained in a container.

An electric arc furnace is a well-known furnace conventionally used for the manufacture of fused products, in particular refractory blocks or abrasive grains. It comprises electrodes between which an electric arc is produced. This arc gives off a large amount of heat, making it possible to melt the feedstock.

An electric arc furnace produces, between electrodes conventionally made of graphite, conventionally in the open air, an electric arc which passes through the feedstock in order to melt it. An electric arc furnace (EAF) differs in particular from a plasma arc furnace (PAF), in which a plasma melts the feedstock, said plasma being generated by the excitation of a gas using an electric arc (which is therefore not used to melt the feedstock directly). The heating dynamics are also very different, which can change the phases of the product manufactured.

Conventionally, the electrodes are said to dip “into the bath of molten material” when they are arranged in such a way that their free end is embedded in said liquid bath during the melting.

A “reducing medium” is a medium that leads to the extraction of oxygen atoms from the molten material. Carrying out melting in a reducing medium does not pose any difficulty. In particular, a reducing agent may be added to the feedstock or, in an electric arc furnace, the process conditions may be adjusted in order to ensure reduction, in particular by bringing the electrodes closer to the bath of molten material, or even by dipping the electrodes into the bath.

When reference is made to “all of the free electrons” or “substantially all of the free electrons”, this is understood to mean all of the free electrons, save for a few exceptions that do not change the measurable properties of the mayenite. When reference is made to “a portion of the free electrons”, this excludes “substantially all of the free electrons”.

The term “median size” of a powder refers to the size dividing the particles into first and second populations equal in mass, these first and second populations comprising only particles exhibiting a size of greater than or equal to, or respectively of less than, the median size. The median size of a powder can be determined using a particle size distribution produced using a laser particle size analyzer.

The terms “comprise”, “include” and “have” should be interpreted broadly and without limitation.

### DETAILED DESCRIPTION

The description which follows is provided for illustrative purposes and does not limit the invention.

### Process for Manufacturing a Mayenite in the Form of an Electride

The process according to the invention may be a process as described for the examples below. It comprises steps a) to f).

In step a), starting materials are conventionally metered so as to obtain the feedstock having the desired composition. Preferably, said starting materials are mixed.

Choosing the starting materials of the feedstock so that the fused product, that is to say the solid mass obtained at the end of step c), has a composition in accordance with that desired does not present any difficulty to a person skilled in the art. Specifically they know how to adapt the feedstock, in particular according to the fly-off of some of the starting materials of the feedstock during the melting.

The feedstock is preferably in the form of a particulate mixture. The median size of at least one starting material of the particulate mixture, preferably of each starting material, is preferably less than 1 mm, preferably less than 0.5 mm.

Preferably, the feedstock contains less than 70%, preferably less than 50%, preferably less than 30%, preferably less than 10%, mayenite comprising calcium and/or strontium, aluminum and oxygen.

More preferably, the feedstock does not contain any mayenite comprising calcium and/or strontium, aluminum and oxygen. Advantageously, the process is simplified.

The elements Ca and/or Sr, and Al are preferably introduced into the feedstock in the form of CaO and/or SrO, and Al₂O₃ oxides. They may also be conventionally introduced in the form of precursors of these oxides, for example in the form of CaCO₃ and/or SrCO₃ phase. The element Al is preferably at least partly introduced into the feedstock in the form of Al₂O₃ phase and/or in the form of precursors of this oxide, for example in the form of aluminum hydroxide and/or boehmite. Preferably, the element Al is introduced into the feedstock partially in the form of Al₂O₃ phase and partially in a metallic form. In one embodiment, the element Al is introduced into the feedstock wholly in the form of Al₂O₃ phase.

In a preferred embodiment, the feedstock comprises a reducing agent, that is to say an agent that creates a reducing medium during the melting, preferably selected from a carbon source, a metal, and mixtures thereof. Preferably, the reducing agent comprises, and preferably consists of, a carbon source, preferably selected from carbon, petroleum coke, pitch, coal and mixtures thereof, preferably petroleum coke. Preferably, the metal is aluminum.

A person skilled in the art knows how to determine a suitable amount of reducing agent. Preferably, the amount of reducing agent in the feedstock is greater than 0.5%, preferably greater than 1%, preferably greater than 1.5% and, preferably, less than 7%, preferably less than 6%, preferably less than 5%, preferably less than 4%, preferably less than 3.5%, as percentage by mass based on the feedstock.

In step b), an electric arc furnace, preferably of Heroult type with graphite electrodes, is used, but all known electric arc furnaces can be envisaged, provided that they make it possible to melt the feedstock in a reducing medium.

Melting in a reducing medium is preferably obtained by the presence, in the feedstock, of a reducing agent and/or by the proximity of the graphite electrodes to the bath of molten material.

The melting of said feedstock is carried out with the electrodes arranged at a distance from the feedstock that is suitable for achieving melting in a reducing medium, preferably in skimming mode, the distance between the electrodes and the feedstock preferably being less than 2 cm, or in a mode in which the electrodes dip into the bath of molten material.

Preferably, the electrodes are in skimming mode or dip into the bath of molten material, and preferably dip into the bath of molten material. Preferably, the feedstock contains a reducing agent. Preferably, the electrodes dip into the bath of molten material and the feedstock contains a reducing agent.

Preferably, the starting materials are melted at atmospheric pressure.

Preferably, the starting materials are melted in an uncontrolled gaseous environment, preferably under air.

Preferably, an electric arc furnace, comprising a 160-litre tank, with a melting energy before casting of more than 1 kWh per kg of starting materials and preferably less than 6 kWh per kg of starting materials, for a power preferably of more than 200 kW, is used, or an electric arc furnace with a different capacity employed under equivalent conditions is used. A person skilled in the art knows how to determine such equivalent conditions.

In step c), the molten material is cooled so as to solidify it and obtain the fused product.

Preferably, the cooling is rapid, preferably such that the molten material is fully solidified in less than 3 minutes, preferably in less than 2 minutes, preferably in less than one minute, preferably in less than 40 seconds, preferably in less than 30 seconds, and preferably in more than 1 second. Rapid cooling may result in particular from casting into molds such as described in U.S. Pat. No. 3,993,119.

Steps a) to c) make it possible in particular to manufacture the fused product comprising a high amount of mayenite electride, comprising free electrons and possibly free oxygens housed in the nano-cages.

In optional step d), the fused product is ground to obtain a powder. Said grinding may be implemented by any conventional technique.

In optional step e), particle size selection is performed on the powder, so as to adapt the particle size of the powder to the targeted application. Particle size selection for example by sieving or cycloning may be employed.

In optional step f), only a portion of the free electrons (and any free oxygens) of the mayenite of said fused product, possibly in the form of a powder, are replaced by at least anions, disposed in nano-cages of the mayenite, preferably selected from F⁻, Cl⁻, OH⁻, H⁻, O₂⁻, O⁻, O₂⁽²⁻⁾, N³⁻, NH²⁻, NH₂⁻, C₂⁽²⁻⁾, S⁻, CN⁻, NO₂⁻, S₂⁻, and mixtures thereof, an anion possibly differing depending on the nano-cage considered or, preferably, being identical irrespective of the nano-cage considered.

Methods for replacing free electrons (and any free oxygens) present in the mayenite of the fused product by anions are well known to a person skilled in the art. For example, H anions may replace at least a portion of the free electrons present in the mayenite of the fused product with the aid of a heat treatment at 1250 °C for 2 hours under 100% H₂ atmosphere.

### Process for Manufacturing an Insulating Mayenite

In a non-preferred embodiment, the process comprises, instead of step f), an optional step f′), during which substantially all of the free electrons (and any free oxygens) of the mayenite of the fused product, possibly in the form of a powder, are replaced by anions, disposed in nano-cages of the mayenite, the electroneutrality of the mayenite being preserved. The anions are preferably selected from F⁻, Cl⁻, OH⁻, H⁻, O₂⁻, O⁻, O₂⁽²⁻⁾, N³⁻, NH²⁻, NH₂⁻, C₂⁽²⁻⁾, S⁻, CN⁻, NO₂⁻, S₂⁻, and mixtures thereof. The anions may differ depending on the nano-cage considered or, preferably, are identical irrespective of the nano-cage considered.

The mayenite, in the form of an electride before step f′), thus becomes electrically insulating.

### Fused Product of Mayenite in the Form of an Electride

A fused product according to the invention comprising more than 90% of a mayenite in the form of an electride preferably has one or more of the following optional features:
the content of oxide compounds is greater than 95%, preferably greater than 96%, preferably greater than 97%, preferably greater than 98%, as percentages by mass based on the mass of the fused product;
the carbon and the oxide compounds together represent more than 99%, preferably more than 99.5%, preferably 100%, of the mass of the fused product;
the carbon content is greater than 15 ppm, preferably greater than 20 ppm, preferably greater than 100 ppm, preferably greater than 300 ppm, preferably greater than 500 ppm, preferably greater than 700 ppm, and/or preferably less than 4%, preferably less than 3%, preferably less than 2%, preferably less than 1.5%, as percentages by mass based on the mass of the fused product;
the amount of mayenite is greater than 92%, preferably greater than 93%, preferably greater than 94%, preferably greater than 95%, preferably greater than 96%, preferably greater than 97%, preferably greater than 98%, preferably greater than 99%, as percentage by mass based on the crystalline phases;
the amount of amorphous phase, measured as described in the examples, is less than 30%, preferably less than 20%, preferably less than 15%, preferably less than 10%, as percentage by mass based on the mass of the fused product;
in a preferred embodiment, preferably for a mayenite in the form of an electride, the total amount of the elements Ca, Sr, Al, C and O, Ca+Sr+Al+O+C, is greater than 97%, preferably greater than 98%, preferably greater than 99%, as percentage by mass based on the mass of the fused product;
the (CaO+SrO)/Al₂O₃ ratio, CaO, SrO, and Al₂O₃ being molar contents based on the oxides, is greater than 1.60, preferably greater than 1.64, preferably greater than 1.68, and preferably less than 2, preferably less than 1.94, preferably less than 1.86, preferably less than 1.80, preferably less than 1.76, preferably less than 1.74;
in one embodiment, the mayenite comprises at least one element selected from Mg, K, Na, Li, Ba, Ga, Si, Ge, Sn, Ti, Zr, Cr, Mn, Fe, Co, Ni, Cu, Zn, preferably substituting Ca and/or Sr and/or Al;
the Raman spectrum of a fused product according to the invention has a band at 1870 cm⁻¹, the Raman spectrum being determined using a monochromatic source with a wavelength equal to 532 nm;
a portion of the nano-cages of the mayenite are occupied by anions, preferably selected from F⁻, Cl⁻, OH⁻, H⁻, O₂⁻, O⁻, O₂⁽²⁻⁾, N³⁻, NH²⁻, NH₂⁻, C₂⁽²⁻⁾, S⁻, CN⁻, NO₂⁻, S₂⁻, and mixtures thereof, said mayenite additionally comprising free electrons;
a portion of the nano-cages of the mayenite are occupied by O²⁻ and a portion of the nano-cages of the mayenite are occupied by anions selected from F⁻, Cl⁻, OH⁻, H⁻, O₂⁻, O⁻, O₂⁽²⁻⁾, N³⁻, NH²⁻, NH₂⁻, C₂⁽²⁻⁾, S⁻, CN⁻, NO₂⁻, S₂⁻, a said anion possibly being identical or differing depending on the nano-cage considered, said mayenite additionally comprising free electrons;
different anions may be housed in different nano-cages of the mayenite or, preferably, all of the nano-cages occupied by an anion are occupied by identical anions, said mayenite additionally comprising free electrons.

In a preferred main embodiment, said fused product according to the invention has:
a content of oxide compounds of greater than 95%, preferably greater than 96%, preferably greater than 97%, preferably greater than 98%, as percentages by mass based on the mass of the fused product, and
a carbon content of greater than 15 ppm, preferably greater than 20 ppm, preferably greater than 100 ppm, preferably greater than 300 ppm, preferably greater than 500 ppm, preferably greater than 700 ppm, and less than 4%, preferably less than 3%, preferably less than 2%, preferably less than 1.5%, as percentages by mass based on the mass of the fused product, and
an amount of mayenite phase of greater than 90%, preferably greater than 92%, preferably greater than 93%, preferably greater than 94%, preferably greater than 95%, preferably greater than 96%, preferably greater than 97%, preferably greater than 98%, preferably greater than 99%, as percentage by mass based on the crystalline phases, and
an amount of amorphous phase, measured as described in the examples, as percentages by mass based on the mass of the fused product, of less than 30%, preferably less than 25%, preferably less than 20%, preferably less than 15%, preferably less than 10%, and
a total amount of the elements Ca, Sr, Al, C and O, Ca+Sr+Al+O+C, of greater than 97%, preferably greater than 98%, preferably greater than 99%, as percentage by mass based on the mass of the fused product, and
a (CaO+SrO)/Al₂O₃ ratio, CaO, SrO, and Al₂O₃ being molar contents based on the oxides, of greater than 1.60, preferably greater than 1.64, preferably greater than 1.68, and preferably less than 2, preferably less than 1.94, preferably less than 1.86, preferably less than 1.80, preferably less than 1.76, preferably less than 1.74.

Preferably, the color of the mayenite of said fused product is between green and black, preferably dark green or black, preferably black.

In one embodiment, the fused product is in the form of a powder, preferably having a median size of greater than 0.1 μm and less than 1 mm.

### Fused Product of Electrically Insulating Mayenite

In one embodiment, which is not preferred, the mayenite is electrically insulating. Said mayenite substantially does not contain any free electrons, a portion of the nano-cages being occupied by anions, preferably selected from F⁻, Cl⁻, OH⁻, H⁻, O₂⁻, O⁻, O₂⁽²⁻⁾, N³⁻, NH²⁻, NH₂⁻, C₂⁽²⁻⁾, S⁻, CN⁻, NO₂⁻, S₂⁻, an anion in a nano-cage being identical or differing depending on the nano-cage considered. Preferably, a portion of the nano-cages of the mayenite are occupied by free oxygens O²⁻ and a portion of the nano-cages of the mayenite are occupied by anions selected from F⁻, Cl⁻, OH⁻, H⁻, O₂⁻, O⁻, O₂⁽²⁻⁾, N³⁻, NH²⁻, NH₂⁻, C₂⁽²⁻⁾, S⁻, CN⁻, NO₂⁻, S₂⁻, a said anion possibly being identical or differing depending on the nano-cage considered.

The invention therefore relates to a polycrystalline fused product comprising more than 90% electrically insulating mayenite, as percentage by mass based on the crystalline phases, said mayenite comprising
calcium and/or strontium,
aluminum and
oxygen,
   said fused product comprising carbon in an amount of greater than 15 ppm and less than or equal to 5%, by mass based on the mass of the fused product.

The fused product has a white color.

The other features described above for the fused product of mayenite in the form of an electride, in particular the features relating to the content of oxide compounds, to the content of carbon and oxide compounds, to the content of carbon, to the amount of mayenite, to the amount of amorphous phase, to the total amount of the elements Ca, Sr, Al, C and O, the ratio (CaO+SrO)/Al₂O₃(CaO, SrO, and Al₂O₃ being molar contents based on the oxides), to the elements that may be present in the mayenite (in particular substituting Ca and/or Sr and/or Al), and to the anions present in the nano-cages, are applicable, optionally, to this embodiment.

### EXAMPLES

The following non-limiting examples are given with the aim of illustrating the invention.

### Measurement Protocols

To determine the composition of a fused product, a bead is manufactured by melting a powder of the fused product. The content of elements other than carbon is measured by X-ray fluorescence, oxygen being considered to be the mass remainder to 100%.

The carbon content of the fused product is measured using a CS744 model carbon-sulfur analyzer, sold by LECO.

The median size of a powder is measured conventionally using a an LA950V2 model laser particle size analyzer sold by Horiba.

The amounts of the various crystalline phases present in the fused product are measured on samples ground in the dry state in an RS 100 mill sold by Retsch, equipped with a bowl and a tungsten carbide wheel, such that the samples are in the form of a powder having an oversize at 40 μm of less than 5% by mass.

A D8 Endeavor machine from Bruker is used for the acquisitions, over a 20 angular range of between 5° and 80°, with a step of 0.01°, and a count time of 0.34 s/step. The front lens comprises a primary slit of 0.3° and a Soller slit of 2.5°. The sample is rotated on itself at a speed equal to 15 rpm, with use of the automatic knife. The rear lens comprises a Soller slit of 2.5°, a 0.0125 mm nickel filter and a 1D detector with an aperture equal to 4°.

The diffraction diagrams are then analyzed qualitatively using the EVA software version 6.0 and the COD database.

The record COD 4308076 of the COD database (Crystallography Open Database) makes it possible to identify the mayenite phase. The peaks of the mayenite phase present in the fused product may have a slight offset from the data records used, depending on the presence of the element Sr and elements selected from Mg, Ga, Si, Ge, Sn, Ti, Zr, Cr, Mn, Fe, Co, Ni, Cu, Zn, and mixtures thereof.

Once the phases present have been identified, the amounts by mass of mayenite and other crystalline phases are evaluated by Rietveld refinement using the HighScore Plus software.

The amount of amorphous phase present in a fused product is measured by X-ray diffraction, using a D8 Endeavour machine from Bruker according to the following method. The diffraction diagram is acquired using this equipment, in the same way as for the determination of the crystalline phases, the sample analyzed being in the form of a powder having an oversize at 40 μm of less than 5% by mass.

After opening the diffraction diagram obtained with the EVA 6.0 software, click on the “define background” icon: a “define background” window appears on the screen.

In the “define background” window, select “original measurement” and “add background as scan”, then check the “Auto Curvature and Threshold” box.

In the “Properties” window of the diffraction diagram, check the “Calculate crystallinity” and “Display amorphous” boxes.

The value for the amount of amorphous phase is the “% amorphous” value in the “Properties” window of the diffraction diagram, as percentage by mass based on the mass of the sample.

### Manufacturing Protocol

The examples were prepared from the following starting materials:
an alumina powder with a purity of greater than 99.8% by mass and having a median size equal to 90 μm,
a calcium carbonate powder with a purity by mass of greater than 99.3% and having a median size equal to 1.6 μm,
petroleum coke.

The fused product of comparative example 1* was prepared according to the teaching of EP 1 717 217, as follows: 37.3 g of alumina powder and 62.7 g of calcium carbonate powder were mixed in a jar mixer for 30 minutes, then the mixture was placed in a carbon crucible, said crucible being closed with a carbon lid. Finally, the crucible thus filled was placed in the quartz tube of a tubular furnace, an argon atmosphere being maintained in said quartz tube during the entirety of the following heat treatment:
rise from ambient temperature up to 1650 °C at a rate equal to 400 °C/h,
hold at 1650 °C for 9 h 30,
descent from 1650 °C down to ambient temperature at a rate equal to 400 °C/h.

The fused product of comparative example 2* was prepared in the same way as example 1*, the feedstock additionally containing 3.1 g of petroleum coke (3%).

The product of example 3 according to the invention was prepared according to the following manufacturing process according to the invention:
a) producing, by mixing, a feedstock consisting of 36.2% alumina powder, 60.8% calcium carbonate powder and 3% petroleum coke, as percentages by mass based on the mass of the feedstock;
b) melting said feedstock in a reducing medium in a single-phase electric arc furnace of Heroult type having graphite electrodes, with a furnace vessel of 0.8 m in diameter, a voltage of 80 V, a current of 2250 A and a specific electrical energy supplied of 3 kWh/kg charged, the electrodes dipping into the bath of molten material;
c) suddenly cooling the molten material by means of a device for casting between thin metal plates such as that presented in the U.S. Pat. No. 3,993,119, such that the molten material is fully solidified in the form of a plate in less than 3 minutes.

The product of example 4 according to the invention was prepared in the same way as the product of example 3, only step c) being different: the molten material was cast into a graphite mold of dimensions 220*200*180 mm³ so as to obtain the fused product. The cooling of the molten material is slower than that carried out for example 3.

The product of example 5 according to the invention was prepared according to the following manufacturing process according to the invention:
a) producing, by mixing, a feedstock consisting of 37.3% alumina powder and 62.7% calcium carbonate powder, as percentages by mass based on the mass of the feedstock;
b) melting said feedstock in a reducing medium in a single-phase electric arc furnace of Heroult type having graphite electrodes, with a furnace vessel of 0.8 m in diameter, a voltage of 88 V, a current of 2250 A and a specific electrical energy supplied of 6 kWh/kg charged, the electrodes dipping into the bath of molten material;
c) suddenly cooling the molten material by means of a device for casting between thin metal plates such as that presented in the U.S. Pat. No. 3,993,119, such that the molten material is fully solidified in the form of a plate in less than 3 minutes.

Table 1 below summarizes the results obtained.

TABLE 1

| | | | | |
|---|---|---|---|---|
| Ex. 1* | Ex. 2* | Ex. 3 | Ex. 4 | Ex. 5 |

Manufacture

| | | | | | |
|---|---|---|---|---|---|
| Reducing agent in the feedstock | — | 3% | 3% | 3% | — |
| | | petroleum | petroleum | petroleum | |
| | | coke | coke | coke | |
| Melting conditions | Closed | Closed | In a | In a | In a |
| | carbon | carbon | reducing | reducing | reducing |
| | crucible | crucible, | medium | medium | medium |
| | | in a | | | |
| | | reducing | | | |
| | | medium | | | |
| Furnace | Tubular | Tubular | Arc | Arc | Arc |
| | under | under | | | |
| | argon | argon | | | |
| | atmosphere | atmosphere | | | |
| Cooling | Slow | Slow | Fast | Slow | Fast |

Results

| | | | | | |
|---|---|---|---|---|---|
| Amount of mayenite | 0 | 34 | 100 | 98 | >98 |
| (percentage by mass based on the mass | | | | | |
| of the crystalline phases) | | | | | |
| Carbon (% by mass based on the mass | n.d. | n.d. | 1.14 | 0.35 | 0.002 |
| of the fused product) | | | | | |
| Ca + Sr + Al + C + O (% by mass based on | n.d. | n.d. | >99.5 | >99.5 | >99.5 |
| the mass of the fused product) | | | | | |
| (CaO + SrO)/Al₂O₃ molar ratio in the | n.d. | n.d. | 1.681 | 1.726 | 1.585 |
| mayenite | | | | | |
| Estimation of the electrical | − | − | ++ | ++ | + |
| conductivity based on the color | | | | | |

n.d.: not determined
*outside the invention

The products of examples 1 and 2 contain little to no mayenite.

The products of examples 3 and 4 are black, which is characteristic of a mayenite electride having a high electrical conductivity.

The product of example 5 is yellow, which is characteristic of a mayenite electride having a low electrical conductivity.

The products of examples 3 to 5 exhibit an amount of amorphous phase of less than 10%, as percentage by mass based on the mass of the fused product.

In example 1, the melting was carried out in a closed carbon crucible placed in a neutral argon atmosphere, the feedstock not comprising a reducing agent. It is found that example 1 does not contain any mayenite, whereas a process according to the invention leads to an amount of mayenite electride of greater than 90%, as percentage by mass based on the mass of the crystalline phases. The virtual absence of mayenite is also contrary to the teaching of EP 1 717 217.

A comparison of examples 1* and 2* shows that, under the same manufacturing conditions, an addition of 3% petroleum coke as a reducing agent to the feedstock (example 2*) increases the amount of mayenite, but is not sufficient to obtain an amount of mayenite phase electride of greater than 90%, as percentage by mass based on the mass of the crystalline phases.

A comparison of examples 2* and 3 shows that, surprisingly, with the same content of petroleum coke (reducing agent) in the feedstock (3%), with the melting being carried out in a reducing medium, the use of an electric arc furnace makes it possible to obtain a fused product comprising more than 90% of a mayenite phase electride, as percentage by mass based on the mass of the crystalline phases.

The considerable increase in the amount of mayenite, which is multiplied by 2.9, is not the result of the sole additional carbon provided by the electrodes, the amount of which is marginal. Nor does it result from a difference in the amount of reducing agent, these amounts being identical for the two examples. Surprisingly, and without it being possible to theoretically explain this at present, this increase is therefore attributed to the use of an electric arc furnace.

A comparison of examples 3 and 4 shows that rapid cooling was favorable with respect to the amount of mayenite.

Lastly, example 5 shows that the presence of a reducing agent is not indispensable for obtaining a high mayenite electride content, provided that the melting is carried out with an electric arc furnace adjusted so as to ensure melting in a reducing medium.

Remarkably, the Raman spectrum of example 3 according to the invention has a band at 1870 cm⁻¹, the Raman spectrum being determined using a monochromatic source with a wavelength equal to 532 nm.

As the examples thus show, the process according to the invention, which is simple and inexpensive because it comprises just a single melting step, makes it possible to manufacture a fused product comprising a very large amount of mayenite electride. In other words, it is not necessary to carry out several heating steps before obtaining the desired amount of mayenite phase.

Of course, the present invention is not limited to the described embodiments provided by way of illustrative and nonlimiting examples.

In particular, the fused products according to the invention are not limited to particular shapes or dimensions.

1. A process for manufacturing mayenite in the form of an electride, said process comprising the following steps:
a) preparing a feedstock;
b) melting said feedstock until a molten material is obtained,
c) cooling said molten material so as to solidify it and obtain a polycrystalline fused product, said feedstock being suitable, in step a), to obtain, at the end of step c), a product comprising more than 90% of a mayenite comprising
calcium and/or strontium,
aluminum and
oxygen,
as percentage by mass based on the mass of the crystalline phases; said method further comprising
d) optionally, grinding the fused product into the form of a powder;
e) optionally, particle size selection on the powder;
said melting being carried out with an electric arc furnace and in a reducing medium.

2. The process as claimed in claim 1, wherein in step b) the electrodes of the electric arc furnace dip into the molten material.

3. The process as claimed in claim 1, wherein in step a) the feedstock comprises more than 0.5% of a reducing agent, as percentage by mass based on the mass of the feedstock.

4. The process as claimed in claim 1, wherein in step a) the feedstock comprises less than 7% of a reducing agent, as percentage by mass based on the mass of the feedstock.

5. The process as claimed in claim 3, wherein the reducing agent is selected from a carbon source, a metal, and mixtures thereof.

6. The process as claimed in claim 1, wherein in step a) the feedstock contains less than 50% mayenite comprising calcium and/or strontium, aluminum and oxygen.

7. The process as claimed in claim 1, wherein the electric arc furnace comprises graphite electrodes and, in step b), the melting of said feedstock is carried out with the electrodes arranged at a distance from the feedstock that is suitable for achieving melting in a reducing medium.

8. The process as claimed in claim 1, wherein in step c) the cooling is adapted such that the molten material is fully solidified in less than 3 minutes.

9. The process as claimed in claim 1, comprising, after step c), and/or, when the process comprises steps d) and/or e), after said steps d) and/or e), a step f) in which only a portion of the free electrons of the mayenite of said fused product are replaced by anions, which are preferably all identical.

10. The process as claimed in claim 9, wherein the anions are selected from F⁻, Cl⁻, OH⁻, H⁻, O₂⁻, O⁻, O₂⁽²⁻⁾, N³⁻, NH²⁻, NH₂⁻, C₂⁽²⁻⁾, S⁻, CN⁻, NO₂⁻, S₂⁻, and mixtures thereof.

11. A process for manufacturing insulating mayenite, said process comprising
a process as claimed in claim 1, and
after step c), and/or, when said process comprises either optional step d) and/or step e), after said steps d) and/or e), a further step f) in which substantially all of the free electrons of the mayenite of said fused product are replaced by anions.

12. The process as claimed in claim 11, wherein the anions are selected from F⁻, Cl⁻, OH⁻, H⁻, O₂⁻, O⁻, O₂⁽²⁻⁾, N³⁻, NH²⁻, NH₂⁻, C₂⁽²⁻⁾, S⁻, CN⁻, NO₂⁻, S₂⁻, and mixtures thereof.

13. A polycrystalline fused product comprising:
more than 90% mayenite in the form of an electride, as percentage by mass based on the crystalline phases, said mayenite comprising
calcium and/or strontium,
aluminum and
oxygen,
wherein said fused product comprising carbon in an amount of greater than or equal to 15 ppm and less than or equal to 5%, by mass based on the mass of the fused product.

14. The fused product as claimed in claim 13,
including more than 95% mayenite in the form of an electride, as percentage by mass based on the crystalline phases; and/or
having a carbon content of greater than 300 ppm and less than 3%; and/or
having a total amount of the elements Ca, Sr, Al, C and O, Ca+Sr+Al+O+C, of greater than 97%, as percentage by mass based on the mass of the fused product; and/or
having a (CaO+SrO)/Al₂O₃ ratio, CaO, SrO, and Al₂O₃ being molar contents based on the oxides, of greater than 1.60 and less than 2; and/or
wherein the mayenite comprises at least one element selected from Mg, K, Na, Li, Ba, Ga, Si, Ge, Sn, Ti, Zr, Cr, Mn, Fe, Co, Ni, Cu, Zn.

15. The fused product as claimed in claim 14,
including more than 98% mayenite in the form of an electride, as percentage by mass based on the crystalline phases; and/or
having a carbon content of greater than 700 ppm and less than 1.5%; and/or
having a total amount of the elements Ca, Sr, Al, C and O, Ca+Sr+Al+O+C, of greater than 98%, as percentage by mass based on the mass of the fused product; and/or
having a (CaO+SrO)/Al₂O₃ ratio, CaO, SrO, and Al₂O₃ being molar contents based on the oxides, of greater than 1.68 and less than 1.80.

16. The fused product as claimed in claim 13, having an electrical conductivity of between 1·10⁻⁴ S/cm and 1 S/cm or an electrical conductivity of greater than 1 S/cm.

17. The fused product as claimed in claim 13, having Raman spectrum having a band at 1870 cm⁻¹, the Raman spectrum being determined using a monochromatic source with a wavelength equal to 532 nm.

18. The fused product as claimed in claim 14, manufactured by a process comprising the steps of:
a) preparing a feedstock;
b) melting said feedstock until a molten material is obtained,
c) cooling said molten material so as to solidify it and obtain a polycrystalline fused product, said feedstock being suitable, in step a), to obtain, at the end of step c), a product comprising more than 90% of a mayenite comprising
calcium and/or strontium,
aluminum and
oxygen,
as percentage by mass based on the mass of the crystalline phases; said method further comprising
d) optionally, grinding the fused product into the form of a powder;
e) optionally, particle size selection on the powder;
said melting being carried out with an electric arc furnace and in a reducing medium.

19. A white polycrystalline fused product comprising:
more than 90% mayenite of the formula ((Ca₂₄Al₂₈O₆₄)⁴⁺)(O²⁻)₂, as percentage by mass based on the crystalline phases, said mayenite comprising
calcium and/or strontium,
aluminum and
oxygen,
wherein said fused product comprising carbon in an amount of greater than or equal to 15 ppm and less than or equal to 5%, by mass based on the mass of the fused product.

20. The fused product as claimed in claim 19, manufactured by a process comprising the steps of:
a) preparing a feedstock;
b) melting said feedstock until a molten material is obtained,
c) cooling said molten material so as to solidify it and obtain a polycrystalline fused product, said feedstock being suitable, in step a), to obtain, at the end of step c), a product comprising more than 90% of a mayenite comprising
calcium and/or strontium,
aluminum and
oxygen,
as percentage by mass based on the mass of the crystalline phases; said method further comprising
d) optionally, grinding the fused product into the form of a powder;
e) optionally, particle size selection on the powder;
said melting being carried out with an electric arc furnace and in a reducing medium,
wherein after step c), and/or, when said process comprises either optional step d) and/or step e), after said steps d) and/or e), a further step f) in which substantially all of the free electrons of the mayenite of said fused product are replaced by anions.

21. A device comprising:
a product as claimed in claim 13, said device being selected from:
a catalyst support;
an electrode of a solid oxide fuel cell;
an organic light-emitting diode;
a Hall-effect thruster;
a gridded ion thruster;
a proton-conducting ceramic fuel cell;
a hydrogen storage and/or transport device, or
a product as claimed in either of claims 19 and 20, said device being selected from:
an electrolyte of a solid oxide fuel cell;
a solid oxide electrolysis cell;
a CO₂ capture device;
a hydrogen storage and/or transport device.
